(19) United States
(12) Patent Application Publication
(10) Pub. No.: US 2010/0001947 A1
(43) Pub. Date: Jan. 7, 2010

(54) Images Display Method and Apparatus of Digital Photo Frame

(75) Inventor: Chia-Ching Lin, Taipei City (TW)

Correspondence Address: NIKOLAI & MERSEREAU, P.A., 900 SECOND AVENUE SOUTH, SUITE 820, MINNEAPOLIS, MN, 55402, US

(73) Assignee: SONNENSCHEIN INDUSTRY CO., LTD., Taipei City (TW)

(21) Appl. No.: 12/261,500

(22) Filed: Oct. 30, 2008

(30) Foreign Application Priority Data
Jul. 2, 2008 (TW) 97211744

(51) Int. Cl. G09G 5/00

(52) U.S. Cl. 345/156

(57) ABSTRACT

The invention describes a digital photo frame which has a motion sensor module. The digital photo frame further comprises a microprocessor, a memory unit, and a display module. User can change photo images displayed by simply shaking the digital photo frame. Any acceleration movements, acceleration changes, gravity changes, tilt, shake, and position changes of the digital photo frame, are detected by the motion sensor module, and the motion sensor module generates signals to the microprocessor for further calculation and interpretation. The microprocessor will then change the displayed photo image to the next image or to the previous image according to the calculation result of the signals.

### BACKGROUND OF THE INVENTION

1. Field of the Invention

The present invention is related to a photo frame, especially to an electronic photo frame.

2. Description of Related Art

Human beings are rich in feelings, and they always miss their families, friends, or the places full of memory. Thus, the technique of photography has come up with the requirement of keeping treasured memories, and the tool to hold and display the photographs, called a “photo frame”, also has become a general and meaningful decoration for an individual or a family.

Long before 16^{th} century, artists have used a camera obscura as a drawing aid. Though it could not develop a photo at that time, the usage of a hole to project images to a flat plane already disclosed the application of basic principles of a pinhole camera. In the year of 1826, the first photograph was developed by a French inventor, but the developing time was too long to let the original technique be commonly used. After taking continual improvements for more than ten years around 1840, scientists successfully established the fundamental technique of photography, which is quite mature today.

According to the development of modern science, digital image technique rising and the size of memory devices increases. At the same time, the quality of images is getting higher, and the application field of the digital image technique is broadened. Beside photographs, there are many applications of digital image technique such as pictures, animations, video, etc.

Digital photography has many advantages over the conventional one, such as providing convenience to copy and share, viewing pictures immediately after taking, and the possibility to edit photos, etc., and these advantages cause the conventional photography to be gradually replaced by digital technique. And speaking of photo viewing, besides developing the photos, a user of a digital camera generally stores the photo data in a computer so as to view on the screen. Therefore, a tool has been developed with the ability of storing and displaying digital photos, so that the user does not need to print out photos in order to put them into photo frames, and this also reduces the inconvenience in changing photos.

However, the available digital photo frames need several operation buttons to change the displayed photos. These buttons not only occupy the display area, but also reduce the convenience in using the digital photo frame, lowering the practical value of it.

### SUMMARY OF THE INVENTION

An objective of the present invention is to provide a digital photo frame which can change the displayed photos by shaking it slightly, in stead of pressing the operation buttons. This not only saves the display area on the surface of a digital photo frame, but also makes it much more faster and convenient to use.

For achieving the objective described above, the present invention provides a digital photo frame, which comprises a microprocessor, for controlling and processing data and module units; a display module, which is coupled with said microprocessor, for displaying images; a motion sensor module, which is coupled with said microprocessor, for detecting motions of the users and generating signals according to the detection; and a memory unit, which is coupled with said microprocessor, for storing image data. Besides the memory unit, a memory card reader can be applied for reading image data in an inserted memory card.

In addition, a calculation and conversion module, which comprises an operational amplifier (OP) and an analog-to-digital converter (ADC), is coupled between said microprocessor and said motion sensor module, for amplifying and converting the signal generated by the motion sensor module and sending the signal to the microprocessor for interpretation. Furthermore, the digital photo frame further comprises a sound generating unit, for generating sounds; and a hardware port, for connecting external devices.

When the motion sensor module detects shake, tilt, displacement, or acceleration changes, it generates signals to the microprocessor, and after the calculation and conversion module between said motion sensor module and said microprocessor amplifies and converts the signals, said microprocessor will then determine to change the displayed photo image to the next image or to the previous image in a sequence of stored images, according to the calculation result of the signals. Therefore, the photo browsing on the digital photo frame no longer requires operation by numerous buttons, and thus the display area and the convenience in using the digital photo frame are increased.

For further understanding of the invention, reference is made to the following detailed description illustrating the embodiments and examples of the invention. The description is only for illustrating the invention, not for limiting the scope of the claim.

### BRIEF DESCRIPTION OF THE DRAWINGS

The drawings included herein provide further understanding of the invention. A brief introduction of the drawings is as follows:

FIG. 1 is a device block diagram of an embodiment according to the present invention;

FIG. 2 is a front view of the device of an embodiment according to the present invention;

FIG. 3 is a back view of the device of an embodiment according to the present invention;

FIG. 4 is a figure indicating the connection of the digital photo frame and an external device according to the present invention;

FIG. 5 is a flow chart of the digital photo frame according to the present invention; and

FIG. 6 and FIG. 7 are figures indicating the operation when using the digital photo frame according to the present invention.

### DETAILED DESCRIPTION OF PREFERRED EMBODIMENTS

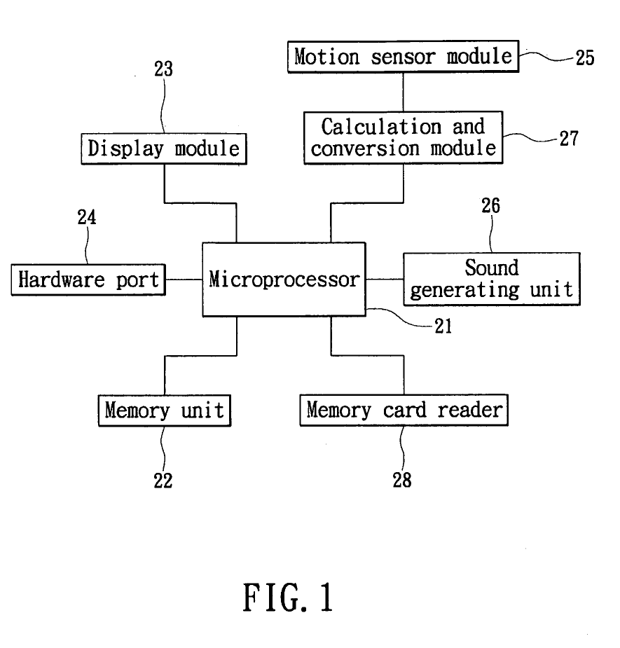

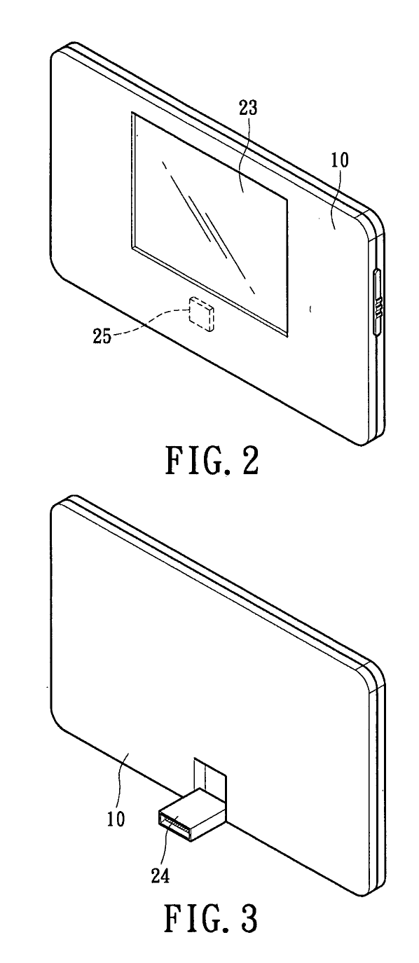

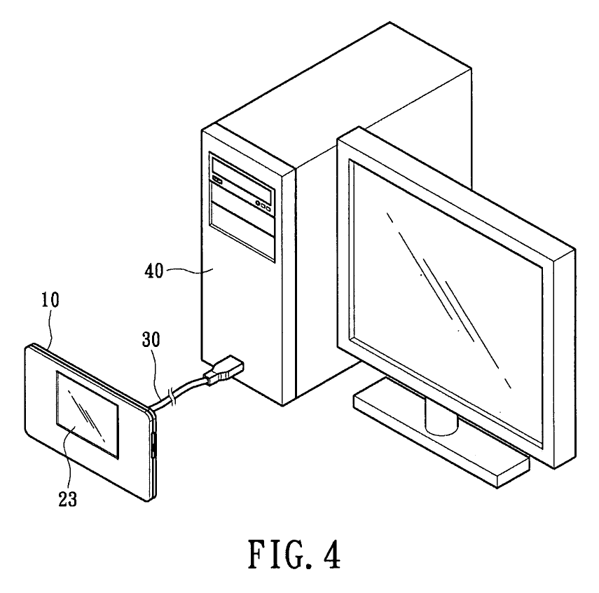

Referring to FIG. 1, FIG. 2, and FIG. 3, which represent the device diagram of an embodiment according to present invention, a digital photo frame 10 comprises a microprocessor 21, for controlling and processing data and module units; a memory unit 22, which is coupled with said microprocessor 21, for storing photo image data; a memory card reader 28, can be applied for reading image data in inserted memory cards; a display module 23, which is on the surface of said digital photo frame 10 and is coupled with said microprocessor 21, for displaying photo images; a hardware port 24, for connecting external devices; a motion sensor module 25, which is coupled with said microprocessor 21, for detecting motions of the users; and a sound generating unit 26, for generating sounds. In addition, a calculation and conversion module 27 is coupled between said microprocessor 21 and said motion sensor module 25. When said motion sensor module 25 detects shake, tilt, displacement, or acceleration changes, it generates signals to said calculation and conversion module 27 for amplifying and converting the signals from analog to digital, and sends the signals to said microprocessor 21 for interpretation. Said microprocessor 21 will then change the displayed photo image to the next image or to the previous image in a sequence of stored images, according to the interpretation result. Wherein the calculation and conversion module 27 comprises an operational amplifier (OP), for amplifying the signals; and an analog-to-digital converter (ADC), for converting the signals from analog to digital.

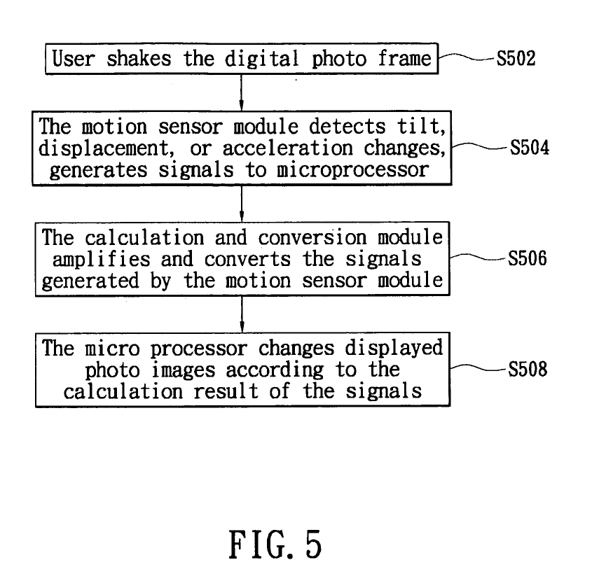

As shown in FIG. 4, which indicates the connection of the digital photo frame with other devices. Corresponding to FIG. 1, FIG. 2, and FIG. 3, the digital photo frame 10 may be connected with an external device such as a computer 40 by a transmission line 30 through the hardware port 24. By the connection, said digital photo frame 10 may exchange data with the computer 40, copy data from the computer 40 into said memory unit 22 or into inserted memory cards through memory card reader 28, or copy data from said memory unit 22 or the inserted memory cards into the computer 40. Furthermore, said digital photo frame 10 can also directly connect with external devices by said hardware port 24 without any transmission line. Wherein the hardware port 24 can be a USB port or other kinds of transmission port.

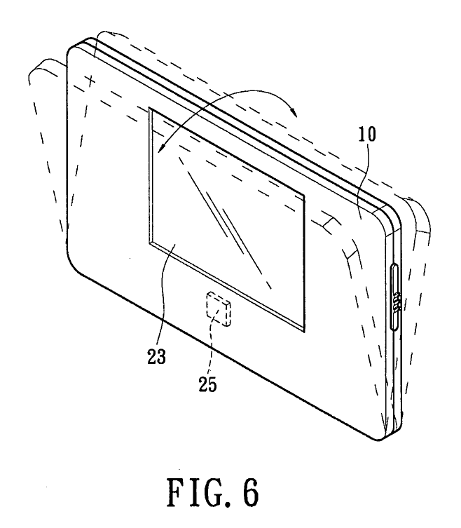

Referring to FIG. 5, which is a flow chart of the operation steps of an embodiment according to the present invention. Corresponding to FIG. 1, after user turn on the digital photo frame 10, said microprocessor 21 reads photo image data from said memory unit 22 and display the photo images on said display module 23. When the user wants to change the displayed photo images, he or she may shake the digital photo frame 10 (S502); after the motion sensor module 25 detects shake, tilt, displacement, or acceleration changes, it sends signals to said microprocessor 21 (S504); said calculation and conversion module 27 amplifies and converts the signals (S506); and then the microprocessor 21 will change the displayed photo image to the next image or to the previous image on the display module 23 according to the signal calculation result (S508).

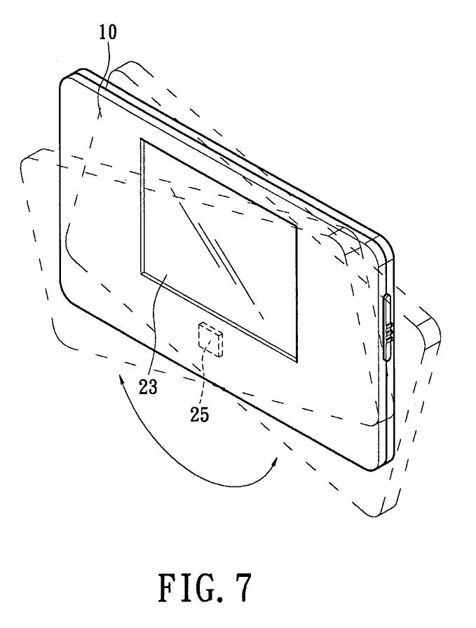

Referring to FIG. 6 and FIG. 7, which indicate the user motions while using the digital photo frame 10. Corresponding to FIG. 1, when the user wants to change displayed photo images, he or she only needs to slightly shake the digital photo frame 10, and after the motion sensor module 25 detects shake, tilt, displacement, or acceleration changes, it sends signals to said microprocessor 21 for further calculation and interpretation, upon which the microprocessor 21 reads the next or the previous photo image data set from said memory unit 22 or the inserted memory card and displays the data on the display module 23. By changing photo images in this way, the operation of the digital photo frame 10 will be much faster and the convenience and practical value of the digital photo frame 10 will be increased. Wherein the motion sensor module 25 may be a G-sensor, an acceleration sensor, a tilt sensor, a ball sensor, a displacement sensor, etc., or any combination of them.

The description above only illustrates specific embodiments and examples of the invention. The invention should cover various modifications and variations made to the structures and operations described herein, and they still fall within the scope of the invention as defined in the following appended claims.

What is claimed is:

1. A digital photo frame, comprising:
a microprocessor, for controlling data and module units of said digital photo frame;
a memory unit, which is coupled with said microprocessor, for storing photo image data;
a display module, which is coupled with said microprocessor, for displaying photo images; and
a motion sensor module, which is coupled with said microprocessor, for detecting motions of users and generating signals to said microprocessor;
whereby said microprocessor controls the images according to the signals generated by said motion sensor module.

2. The digital photo frame as in claim 1, whereby after said motion sensor module detects the motion of the digital photo frame, the motion sensor generates signals to said microprocessor for interpretation, and said microprocessor then reads the next or the previous photo image data set from said memory unit and displays the data on said display module.

3. The digital photo frame as in claim 1, further comprising a sound generating unit, which is coupled with said microprocessor, for generating sounds.

4. The digital photo frame as in claim 1, further comprising a hardware port, which is coupled with said microprocessor, for connecting external devices.

5. The digital photo frame as in claim 1, wherein said motion sensor module comprises a device selected from the group consisting of G-sensors, acceleration sensors, tilt sensors, displacement sensors, and ball sensors.

6. The digital photo frame as in claim 1, further comprising a calculation and conversion module, which is coupled between said microprocessor and said motion sensor module, for amplifying and converting the signals generated by said motion sensor module.

7. The digital photo frame as in claim 6, wherein said calculation and conversion module comprises an operational amplifier and an analog-to-digital converter.

8. A digital photo frame, comprising:
a microprocessor, for controlling data and module units of said digital photo frame;
a memory card reader, which is coupled with said microprocessor, for reading photo image data from inserted memory cards;
a display module, which is coupled with said microprocessor, for displaying photo images; and
a motion sensor module, which is coupled with said microprocessor, for detecting motions of users and generating signals to said microprocessor;
whereby said microprocessor controls the images according to the signals generated by said motion sensor module.

9. The digital photo frame as in claim 8, whereby after said motion sensor module detects the motion of the digital photo frame, it generates signals to said microprocessor for interpretation, and said microprocessor then reads the next or the previous photo image data set from said inserted memory cards through said memory card reader and displays the image data on said display module.

10. The digital photo frame as in claim 8, further comprising a sound generating unit, which is coupled with said microprocessor, for generating sounds.

11. The digital photo frame as in claim 8, further comprising a hardware port, which is coupled with said microprocessor, for connecting external devices.

12. The digital photo frame as in claim 8, wherein said motion sensor module comprises a device selected from the group consisting of G-sensors, acceleration sensors, tilt sensors, displacement sensors, and ball sensors.

13. The digital photo frame as in claim 8, further comprising a calculation and conversion module, which is coupled between said microprocessor and said motion sensor module, for amplifying and converting the signals generated by said motion sensor module.

14. The digital photo frame as in claim 13, wherein said calculation and conversion module comprises an operational amplifier and an analog-to-digital converter.

15. An images display method of a digital photo frame, comprising:
providing a motion sensor module in said digital photo frame; and
controlling the images displayed on the digital photo frame according to the signals generated by said motion sensor module.

16. The images display method as in claim 15, wherein said controlling consists of changing a displayed image to the next image or to the previous image in a sequence of stored images, according to the signals generated by said motion sensor module.

17. The images display method as in claim 15, wherein said motion sensor module comprises a device selected from the group consisting of G-sensors, acceleration sensors, tilt sensors, displacement sensors, and ball sensors.
